(19) United States
(12) Patent Application Publication
(10) Pub. No.: US 2024/0346442 A1
(43) Pub. Date: Oct. 17, 2024

(54) SYSTEM AND METHOD FOR REAL-TIME PATRY INVENTORY

(71) Applicant: Smart Sense LLC, Tampa, FL (US)

(72) Inventors: Krishanakanth Barri, Wesley Chapel, FL (US); Harischandra Prasad Tirumani, Tampa, FL (US); Venkata Vinay Tej Palepu, Tampa, FL (US)

(21) Appl. No.: 18/634,802

(22) Filed: Apr. 12, 2024

Related U.S. Application Data
(60) Provisional application No. 63/459,253, filed on Apr. 13, 2023.

(51) Int. Cl. G06Q 10/087; G01G 19/414; G01G 23/01; G01V 3/08

(52) U.S. Cl. CPC G06Q 10/087; G01G 19/414; G01G 23/01; G01V 3/08

(57) ABSTRACT

A real-time pantry inventory management system for a plurality of food containers storing a plurality of food items being supported by a storage element, comprises a plurality of presence sensors each affixed to one of the plurality of food containers; at least one weight sensor coupled to the storage element; and a processor configured to receive real-time presence data from the plurality of presence sensors and real-time weight data from the at least one weight sensor, and automatically determine a real-time inventory of food items associated with the storage element based at least in part on the real-time weight data and real-time presence data.

### RELATED APPLICATION

The present application claims the benefit of the filing date of U.S. Provisional Patent Application U.S. 63/459,253 filed on Apr. 13, 2023, incorporated herein by reference in its entirety.

### TECHNICAL FIELD

This disclosure relates to a system and a method for real-time pantry inventory so that a user always knows what food items in the home pantry need to be replenished.

### BRIEF DESCRIPTION OF THE DRAWINGS

FIG. 1 is a simplified block diagram of a preferred embodiment of a real-time pantry inventory and management system and method according to the teachings of the present disclosure;

FIG. 2 is a simplified flowchart of a preferred embodiment of a real-time pantry inventory and management method according to the teachings of the present disclosure;

FIGS. 3-5 are various views of an embodiment of presence sensors and weight sensors according to the teachings of the present disclosure;

FIGS. 6A-6C are various views of the detail of the weight sensor;

FIG. 7 are various views of an embodiment of a presence sensor using the free-fall pin technology according to the teachings of the present disclosure;

FIG. 8 is a top plan view of circuitry details of a presence sensor using the free-fall pin technology according to the teachings of the present disclosure;

FIGS. 9A and 9B are additional views of the details of the presence sensor using the free-fall pin technology according to the teachings of the present disclosure;

FIGS. 10A-10D are various views of a free-fall pin and magnetic detection technology used for presence detection according to the teachings of the present disclosure;

FIGS. 11A-11D are various views of a magnetic detection technology used for presence detection according to the teachings of the present disclosure; and

FIGS. 12A-12C are three views of a gyroscope and/or acceleration sensor technology used for presence detection according to the teachings of the present disclosure.

### DETAILED DESCRIPTION

The invention is in the field of active and real-time inventory management of food items in a food pantry. The invention provides a live inventory system, assisting with auto-ordering, and identifying retailers with discounts and coupons for the items being ordered. The invention also prevents food waste because items are ordered only when inventory is low. The invention also avoids unnecessary trips to the store, which helps to cut down on carbon emissions, and decrease the carbon footprint of households.

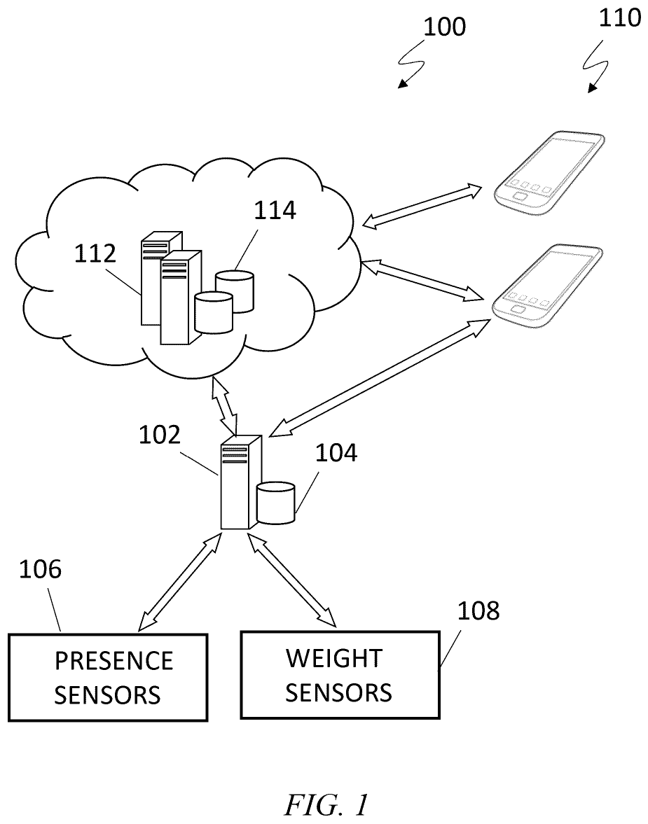

Referring to FIG. 1, the system and method 100 described herein enables the user to manage their pantry inventory on a real-time basis. The system and method 100 enable the user to manage the inventory by providing a real-time list of items that drop below the thresholds set by the user. The inventory system and method 100 track the usage of food items on a real-time basis and incorporates hardware (e.g., processor/microprocessor/server 102, data storage/database 104, presence sensors 106, and weight sensors 108) and software, such as a mobile app that executes on a user's mobile phone 110 or other mobile devices, and software executing on cloud-based servers 112 that access data stored in cloud-based databases 114. The user may use the mobile app to access real-time inventory data stored locally in the local data storage device 104 as well as access the inventory data stored in the cloud-based database 114. The components of the system 100 may communicate via any suitable wired or wireless communication methods and protocols now known or to be developed.

Traditional strain gauge weight sensor measures weight or force by detecting strain or deformation of an object under stress. Strain gauge weight sensors are placed under the shelf at specific points where they can detect the strain induced by the weight change placed on the shelf through the change in electrical resistance. However, the shelf base may not be the same size across the shelves and also may not be the same across the homes. This requires shelf bases of various sizes in width and length to be manufactured to fit all the various shelves. In addition, the level of the shelf base may not be flat enough that all the sensors will be in touch correctly all the time. Uneven strain distribution can also make it challenging to accurately calibrate the sensors because if the strain distribution is non-uniform, the relationship between strain and weight may not be consistent across the entire shelf surface.

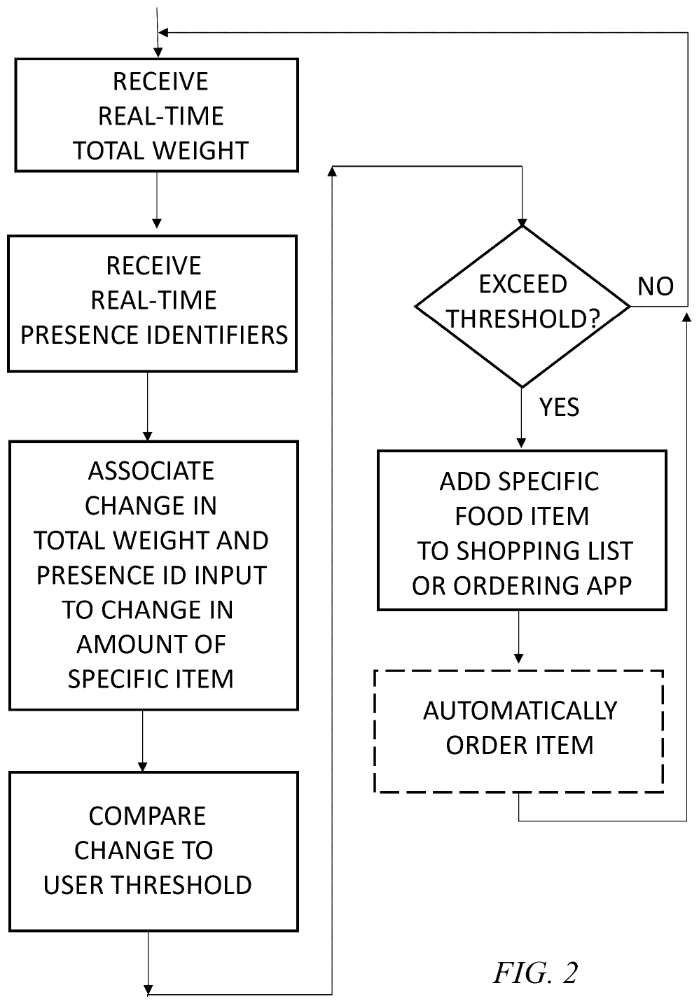

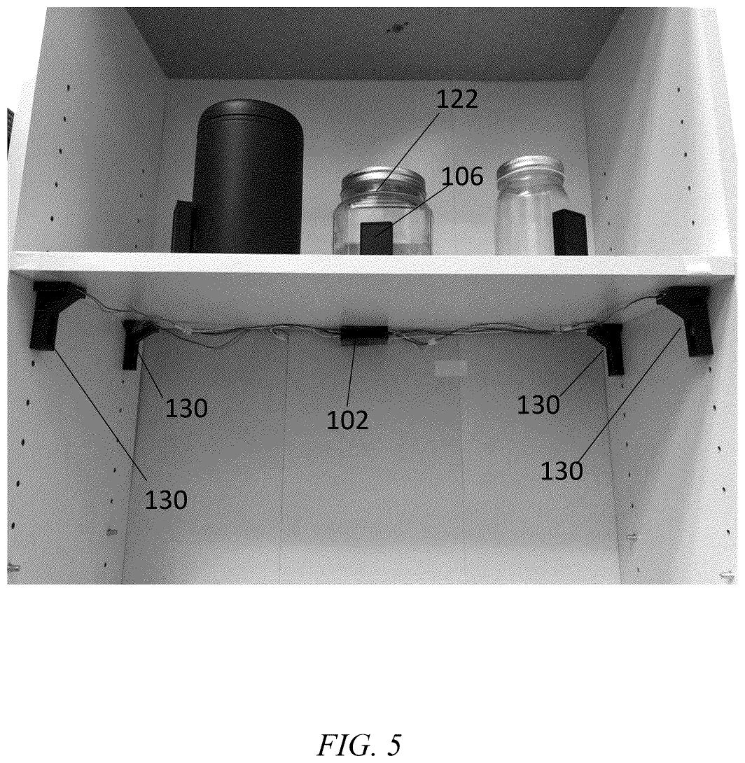

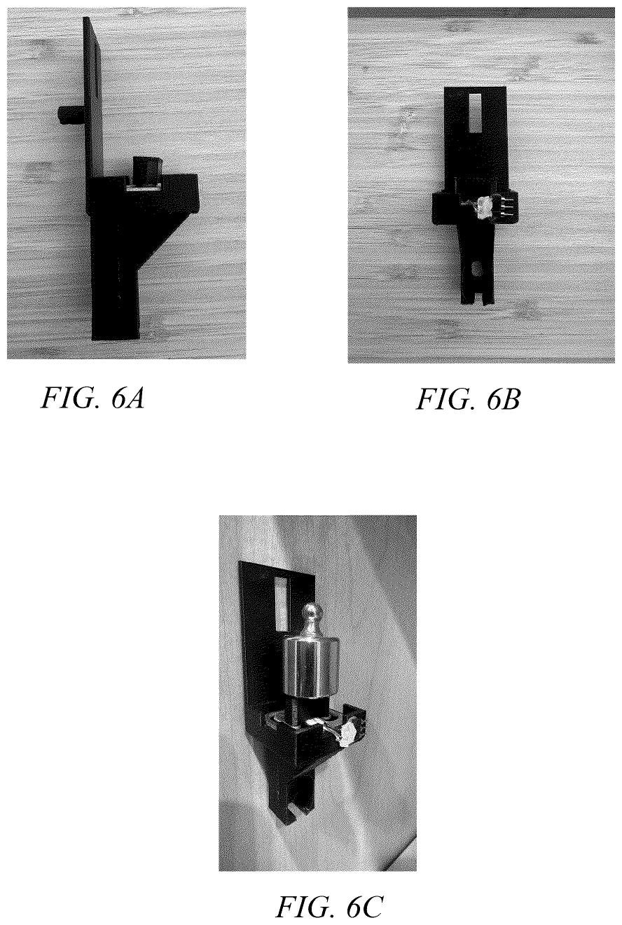

In one embodiment, as shown in FIG. 2, the local processor receives the real-time total weight measurement provided by the weight sensor(s) (FIG. 5) associated with each shelf, rack, tray, drawer, box, or similar storage element. In the present invention, separate weight sensors are used. Each weight sensor is seat shaped. The backrest part of the weight sensor is the vertical part that can be placed against the side walls of a pantry. The horizontal part is where the sensor is positioned. A recess of the horizontal part accommodates the sensor. External weight induces movement of the sensor within the recess, thereby eliciting a change in the electrical resistance, which is in direct proportion to the amount of external weight change. A processor is placed underneath the shelf which has connections to all these weight sensors. Each food container 122 has a presence sensor 106. The processor can receive the signals from the presence sensors 106 of different food containers 122, analyze the signals, identify the respective container weight, and send the information to the local or cloud database. Sometimes, food containers 122 without presence sensors 106 are also placed on the shelf. This will not impact the container measuring capability for the containers with presence sensors 106.

Unlike the traditional method that all the four sensors are interconnected within a Wheatstone bridge configuration and the weight value gets averaged by this connection method, in the present invention, all the sensors are measured individually and applied to a logic to identify which sensor is touching the shelf base and which sensor is not touching the shelf base. All the sensor values are considered to get the actual weight of an item that is placed on the shelf base. In this method, even if one or multiple sensors are not touching the base, the item weight can be calculated correctly. Each time a sensor is affixed to the shelf, calibration is conducted. Different calibration weights are placed on the shelf base one at a time, starting from the lowest weight, progressing to the highest, and allowing the weight sensors to stabilize and settle for each calibration weight. Record the sensor readings for each calibration weight and store the calibration values associated with the specific sensor being calibrated in a database for future calculation. During weight sensor operation, periodically apply the data in the database to correct weight measurements. This overcomes the restriction of the traditional method that all the sensors have to be at the same level and in contact with the shelf base.

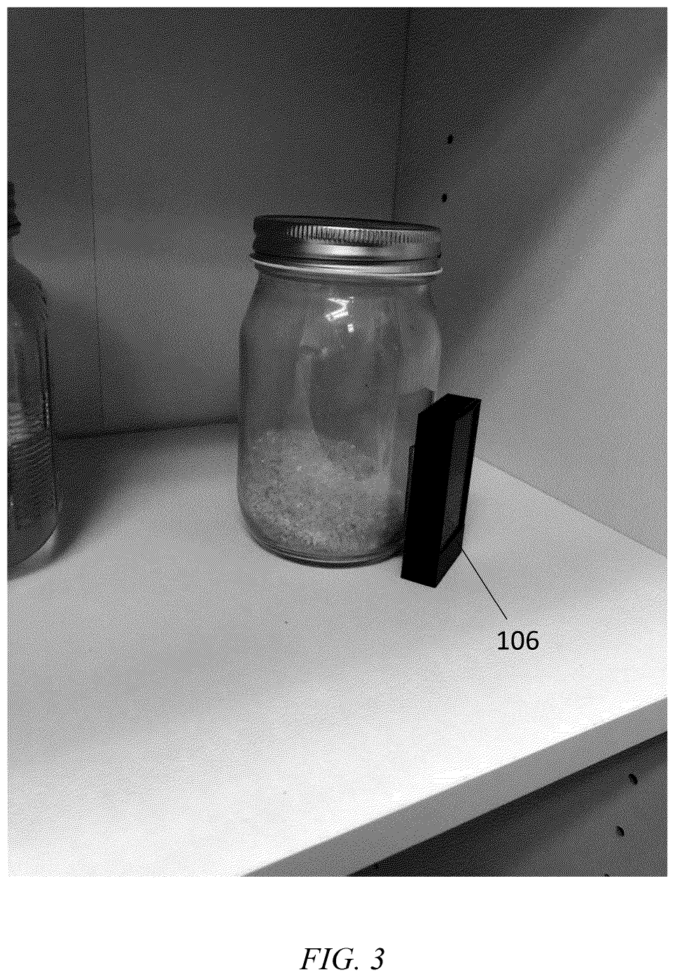

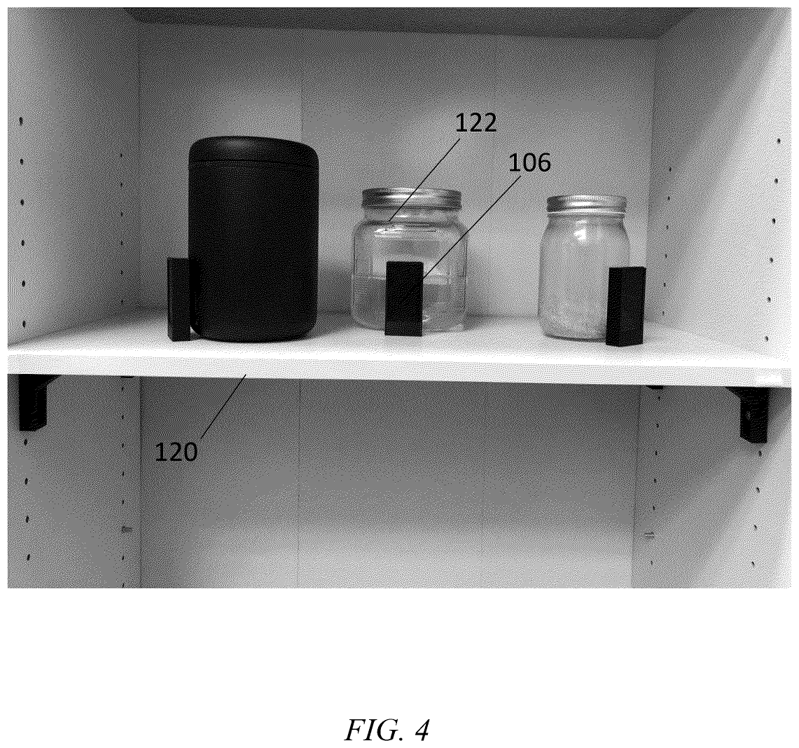

The total weight represents the weight of the storage element/shelf base 120, the containers and food items inside the containers, along with the sensors attached to each container, as shown in FIGS. 3 and 4. The processor also receives presence data from the presence sensors 106 that are coupled to or associated with the food containers 122 on the shelf. The presence data includes the unique identifiers (IDs) that are associated with the food items that are present on the shelf, rack, or storage element 120. Each unique ID is associated with a particular food container 122 that holds a particular food item. When a user removes a food container 122 from the shelf, the presence data received by the processor indicates an absence of that particular food container 122. The total weight is then analyzed along with the present unique IDs to determine the weight of the remaining food items and the food item that was removed. When the food item is placed back on the shelf, if there is any change in the total weight measurement, that weight data is then attributed to the weight change of that specific food item.

The algorithm logic is able to keep track of the real-time weight measurement and the contemporaneous presence IDs that are present and absent to determine the real-time weight of the food items. The weight change is then used as a data point to be compared to the user's preset threshold for that food item. If the user's setpoint or threshold is exceeded, indicating that food item is about to run out, then that food item is automatically added to a shopping list or put into the shopping cart of an ordering app. Optionally, an order is automatically submitted for the specific identified food item either with or without the user's acknowledgement or authorization. The system may further assist with identifying retailers that offer a discount of the food item that needs to be replenished and automatically placing an order with the retailers that offer the best price with the highest ratings.

The real-time inventory and shopping list are stored locally as well as uploaded to the cloud-based server and database. As shown in FIG. 1, the user may access the real-time inventory and shopping list either directly from the local database or the cloud-based database.

Below is an example of how the process works:
1. The shelf is holding the following containers:
   a) Container-01's unique ID is ID-1 and it contains “Honey”, its individual weight is 1.0 lb.
   b) Container-02's unique ID is ID-2 and it contains “Sugar”, its individual weight is 0.5 lb.
   c) Container-03's unique ID is ID-3 and it contains “Cereal”, its individual weight is 0.25 lb.
   NOTE: This Container-ID to food item association will be done by the user in the application when he/she attaches the presence sensor to the container for the first time.
2. Assume Container-01 and Container-02 are already on the shelf and total weight is 1.5 lb.
3. The weight sensor measures the weight of the shelf and the processor knows the total weight is 1.5 lb and it stores this value in its memory as a current shelf weight.
4. Now the user has placed the Container-03 on the shelf.
   When the user places the container, the presence sensor will identify that it has been placed on the shelf and send its unique ID, that is ID-3 to the processor.
   At the same time the total weight on the shelf has changed.
5. Weight sensor measures the new weight (total 1.75 lb) and calculates the deviation from the earlier value (1.5 lb). So, the increase in weight was 0.25 lb.
6. Also, the processor received that ID-3 has been placed on the shelf, which is a new container that came on to the shelf at that time.
7. The processor associates the changed weight, that is 0.25 lb to the container with ID-3. By this the system will know that “Cereal” weight is 0.25 lb.
8. Now the user has removed Container-02 (“Sugar”) from the shelf.
9. The total shelf weight will become 1.25 lb and the processor will store this value in its memory.
10. Let us assume the user removed 0.1 1b Sugar from the container.
11. The user placed the Container-02 again on the shelf.
12. Now the process will be the same as Step-4 to Step-7.

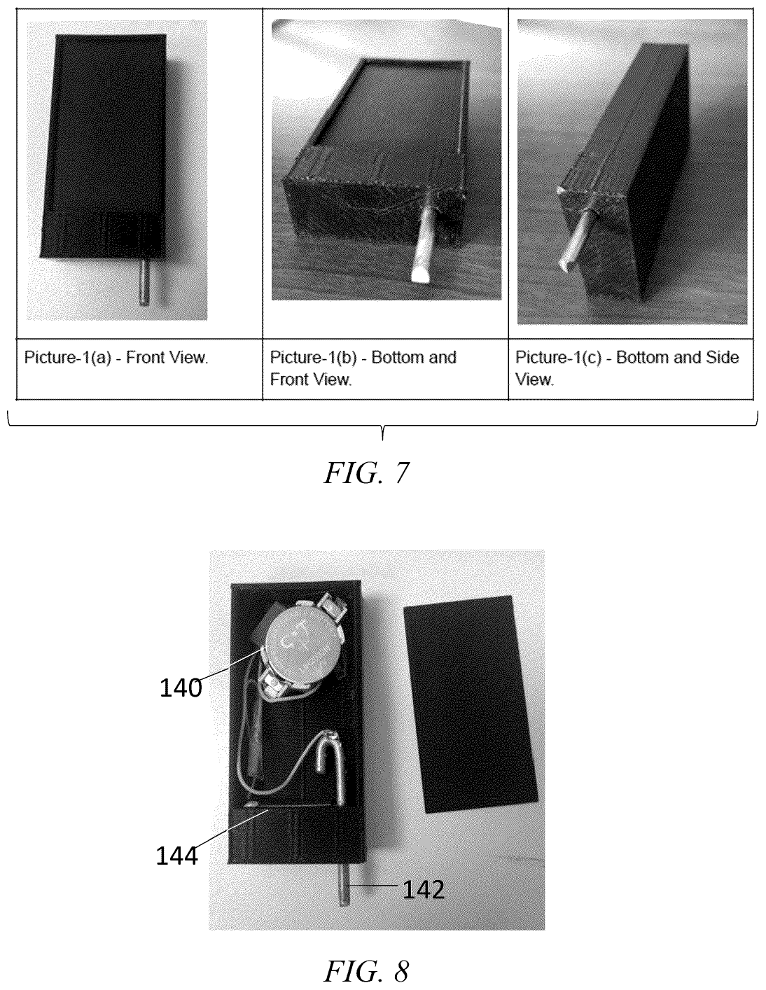

The system 100 described herein may incorporate presence sensors 106 shown in FIGS. 7-9 and described in more detail below. The presence sensor's primary function is to detect the presence of a food container 122 on the rack/shelf. It will detect the event of placing/removing the food container 122 on the shelf. Once the sensor detects that the food container 122 is placed/removed on/from the shelf, it will send its unique ID that was assigned at the time of manufacturing the device along with the event details to the processor. The presence sensor device's unique ID cannot be altered by the end user. This helps in maintaining and identifying each presence sensor uniquely. The same information will be used by the processor in the solution along with the weight change to identify the food container's current weight.

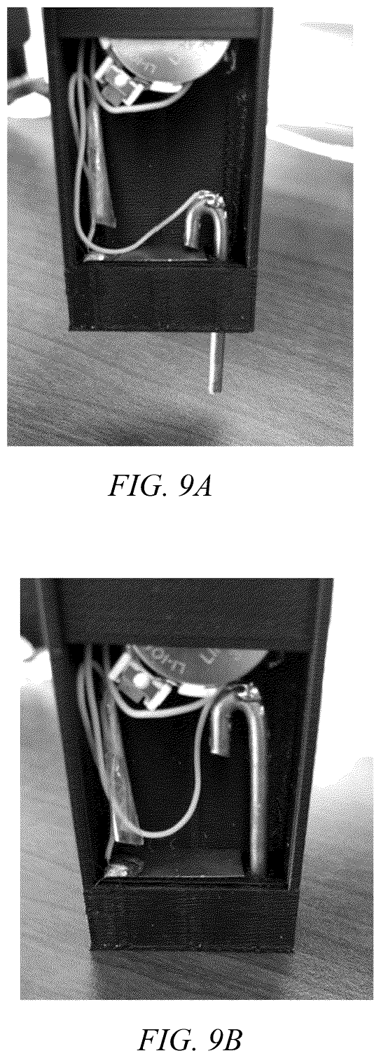

The presence sensor has a “pin” and a “plate” that are both made of a conducting metal, such as copper, as shown in FIG. 8. When the pin 142 and plate 144 are in contact, they conduct an electrical current from a battery 140, and the current passes through them and they act as a closed switch. When the pin 142 and plate 144 are not in contact, the battery 140 current does not pass through them and the plate 144 and pin 142 act as an open switch. This open and close behavior is used to detect whether the food container is placed or removed on/from the shelf. The pin 142 has a U-shaped bend that terminates in one leg being substantially longer than the other leg.

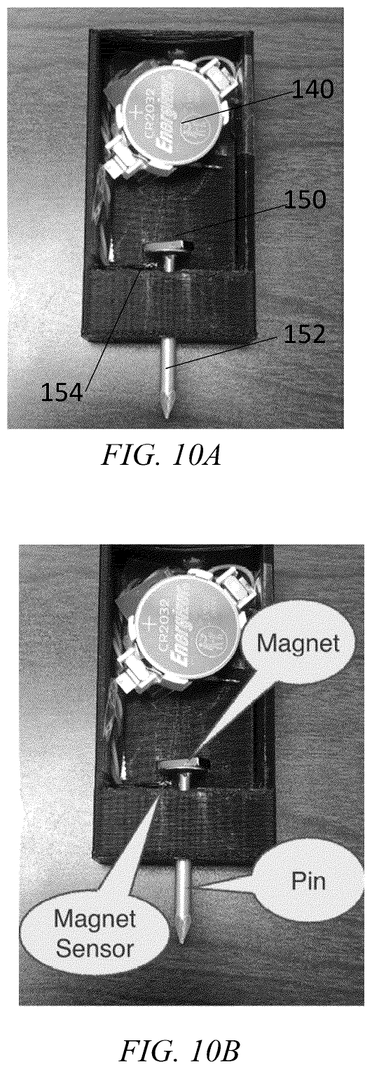

As best shown in FIG. 8, the longer leg of the pin 142 passes through a small opening located at the bottom surface of the sensor housing with zero friction. The presence sensor is affixed to the food container so that the longer leg of the pin 142 can protrude beyond the sensor housing. A plate 144 is affixed to the battery 140. When the food container and the presence sensor are lifted above the shelf, the weight of the pin 142 causes the longer leg of the pin 142 to fall and extend beyond the sensor housing via the small opening, which causes the shorter leg of the pin 142 to makes contact with the plate 144, as shown in FIG. 9A. When the pin 142 contacts the plate 144, the presence sensor is in an ON state, indicating that the food container has been lifted off the shelf. When the food container is placed on the shelf, the longer leg of the pin 142 in the presence sensor affixed to the food container is forced inside the sensor housing, and the shorter leg of the pin 142 is lifted away from the plate 144, as shown in FIG. 9B. The presence sensor is in the OFF state, indicating that the food container is sitting on the shelf.

The presence sensor has a processor and a Bluetooth communication module as well to help in sending the ON/OFF state information to another processor that is attached to the shelf. When inactive for a predetermined amount of time, the presence sensor, the sensor processor and Bluetooth module are in sleep mode to not consume battery power. This helps to conserve battery life. Due to the pin movement, when the ON/OFF state changes, an event will be triggered in the sensor processor. Once the ON/OFF event is triggered, the sensor processor wakes up from sleep mode and sends the sensor's unique ID to the other processor using Bluetooth wireless technology. Once it sends the information to the second processor, the sensor processor and Bluetooth modules may go into sleep mode again to save battery power. Each time the presence sensor changes state, i.c., from ON to OFF or from OFF to ON, its unique ID is transmitted to the processor.

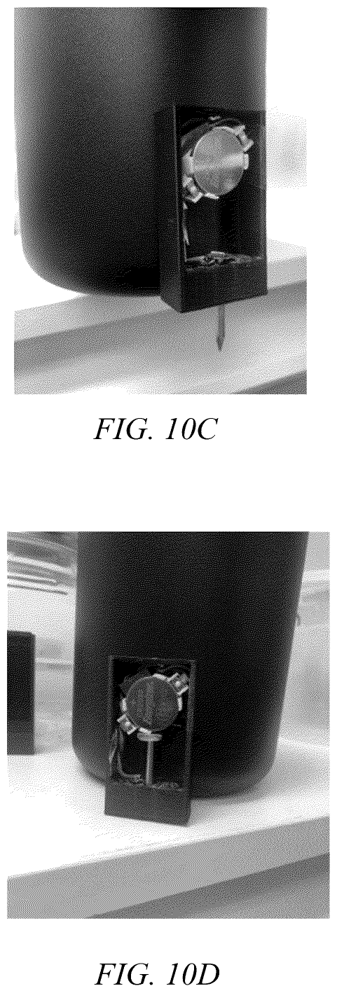

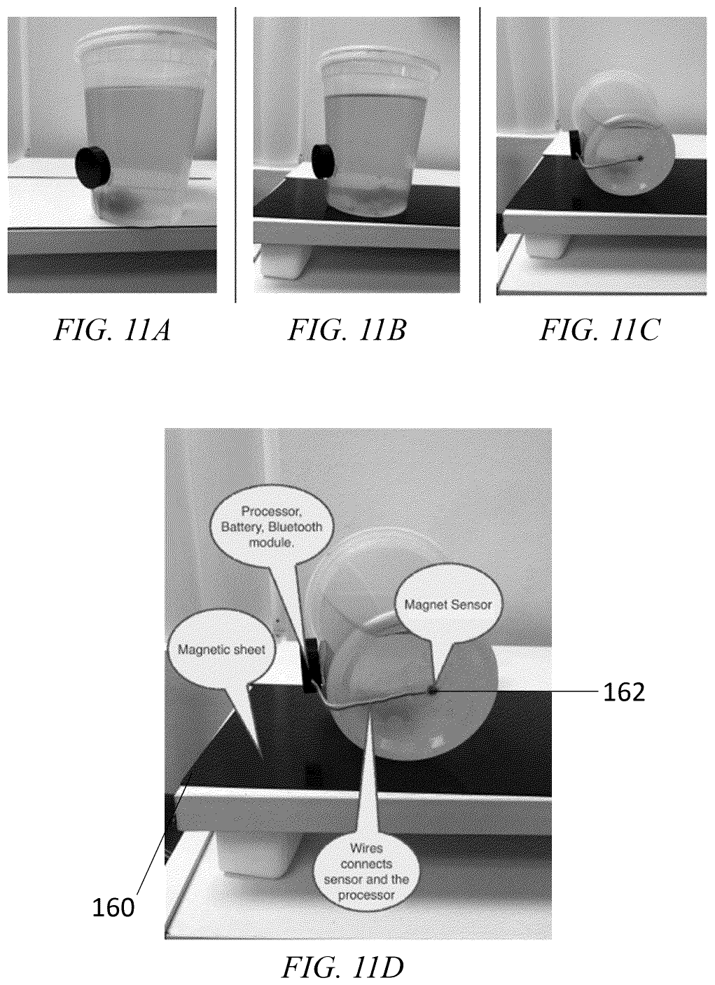

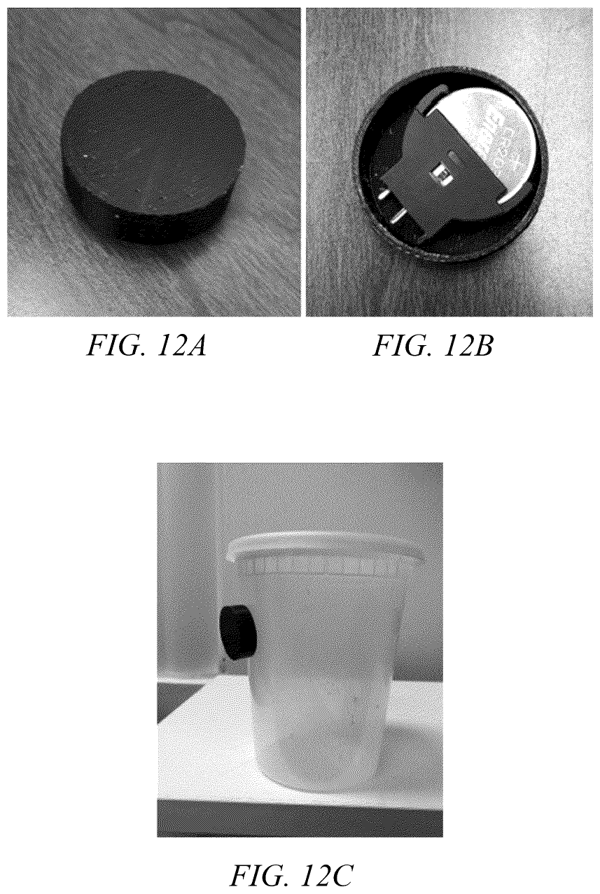

In addition to the mechanism described above for presence detection, any suitable method can be used. For example, other presence detection techniques include free-fall pin and magnet detection (FIGS. 10A-10D), magnet detection (FIGS. 11A-11D), gyro and/or acceleration detection (FIGS. 12A-12C), tilt and/or vibration sensor technology, and distance sensor technology.

The presence sensor based on the free-fall pin and magnetic detection technology includes a pin 152, a magnet 150, and a magnet sensor 154, such as a half-effect sensor. The magnet is affixed on top of the pin and the pin is positioned in the hole on the bottom of the housing without any obstruction. The pin can freely pass through the hole without any friction. Due to the weight of the pin, when the presence sensor is lifted above the shelf, the pin freely falls through the small opening of the sensor housing. This pin will stop going down further when the head portion of the pin touches a “plate” inside the sensor housing. The magnet disposed on top of the head portion of the pin touches or comes close to the magnet sensor when the pin falls through the sensor housing (when the food container is lifted). When the magnet comes close to the magnet sensor, it activates and acts as an ON state. When the sensor is lifted and not on the shelf, the position of the pin is shown in FIG. 10C. In this position, the magnet touches or is close to the magnet sensor. As shown in FIG. 10D, when the sensor is placed on a shelf, the pin is pushed upwards by the shelf surface until the bottom part of the pin and bottom part of the presence sensor are at the same level. In this position, the magnet is positioned away from the magnetic sensor. This is the OFF state of the presence sensor. The presence sensor has a processor (processor-1) and Bluetooth module to enable transmission of the state information to the other processor (processor-2) which is attached to the shelf. The processor-1 and Bluetooth module will be in sleep mode to not consume battery power for a prolonged time. This helps in running the device on battery for a long time. Due to the pin movement and magnet attached to it, when ON/OFF state changes, an event will be triggered in the processor-1. Once the ON/OFF event is triggered, the processor-1 wakes up from sleep mode and sends the sensor's unique ID to the processor-2 using Bluetooth wireless technology. Once it sends the information to the processor-2, then processor-1 and Bluetooth modules go into sleep mode again to save battery power.

Another embodiment uses magnet detection technology. The presence sensor will have a magnetic sensor such as a hall-effect sensor or a reed switch that will activate when it is placed near any magnetic material. The magnet sensor 162 along with the processor will be affixed to the food container placed on a shelf with a magnetic sheet 160 or liner laid on the top surface of the shelf. The magnet sensor 162 will be positioned on the food container in such a way that the magnet sensor 162 will be in close proximity to the magnetic sheet 160 when the food container is placed on the shelf. When the food container is placed on the shelf base, the magnet sensor 162 will get activated. This activation will trigger a signal in the processor, and it will send its unique ID to processor-2 which is affixed to the shelf. FIGS. 11A-11D show various views of the presence sensor using the magnetic sensor technology.

In another embodiment, FIGS. 12A-12C show the presence sensor using gyroscope and/or acceleration technology. In this embodiment, the processor monitors the change in axis values of the gyroscope and/or accelerometer (affixed to the food container), which is indicative of the change in position/orientation of the food container. When the change in axis values exceeds a predefined threshold, it assumes that the food container has been moved. When it moves, it tracks and analyzes the position across the axis and/or acceleration when the container comes to a stable state. When it comes to a stable state from the moving state, it sends its unique ID to processor-2 that is affixed to the shelf. By tracking and analyzing the position across the three axes using gyroscope and the acceleration values from the accelerometer, the container's path can be identified and used to determine whether the container is moved out of the shelf or placed back on the shelf. The use of this technology is helpful to determine false triggers.

In another embodiment, the presence sensor employs the tilt and/or vibration technology. The presence sensor will have a tilt and/or vibration sensor. The tilt and/or vibration sensor is placed inside the case along with the battery, processor, and Bluetooth module. The tilt and vibration sensor can detect when a food container is moved or lifted off the shelf. These movements of the container activate the tilt/vibration sensor. The sensor processor will monitor these tilt/movement state changes and detect when the food container is stable on the shelf again. Once it identifies that the container is back on the shelf, the sensor processor sends its unique ID to processor-2 affixed to the shelf.

The system and method described herein may implement both presence sensors and distance sensors with the gyroscope/gyrometer and accelerometer technology. These sensors may be placed in a sensor housing that is attached to a food container. The distance sensor is capable of measuring the distance between the food container and the shelf base that the food container sits on and identifying whether the food container still sits on the shelf.

In another embodiment, the presence sensor also includes an accelerometer and/or gyroscope/gyrometer as well that generates a signal when the food container is moved in any direction or in any angle. This signal is used to start the tracking of the distance from the food container to the shelf. The tracking continues as long as the food container is moving. Once it stops moving, the distance sensor analyzes the measured distance and identifies whether the food container is lifted from the shelf or placed on the shelf. Once it comes to a stable state, and the analysis of the distance is completed, it will send the information along with the presence sensor's unique ID using the Bluetooth communication to the processor attached to the shelf. The presence sensor and the accelerometer and/or gyroscope/gyrometer identify which food container is measured and whether the food container is still on the shelf. The weight sensor detects whether the weight of the food item in the food container drops below the thresholds set by the user.

It should be noted that although this invention has been described in the context of homes and households, it can be used in commercial applications as well. The real-time pantry inventory system and method may also be used for tracking the inventory of non-food items. It should also be understood that the system and method described herein are able to associate the weight measurement with any non-weight threshold set by the user, such as gallon, quart, etc. to make comparisons.

The features of the present invention which are believed to be novel are set forth below with particularity in the appended claims. However, modifications, variations, and changes to the exemplary embodiments described above will be apparent to those skilled in the art, and the invention described herein thus encompasses such modifications, variations, and changes and are not limited to the specific embodiments described herein.

What is claimed is:

1. A real-time pantry inventory management system for a plurality of food containers storing a plurality of food items being supported by a storage element, comprising:
a plurality of presence sensors each affixed to one of the plurality of food containers;
at least one weight sensor coupled to the storage element; and
a processor configured to receive real-time presence data from the plurality of presence sensors and real-time weight data from the at least one weight sensor, and automatically determine a real-time inventory of food items associated with the storage element based at least in part on the real-time weight data and real-time presence data;
wherein the processor processes the real-time presence data and the real-time weight data to determine if the weight of the food items is under predetermined thresholds, and generate inventory data.

2. The real-time pantry inventory management system of claim 1, wherein a unique identifier is assigned to each of the plurality of food containers, and the real-time presence data received by the processor includes the unique identifiers.

3. The real-time pantry inventory management system of claim 1, further comprising:
at least one magnetic sheet on the storage element, upon which the plurality of food containers are placed;
wherein each of the plurality of presence sensors further comprises a magnetic sensor component configured to detect if the food container remains on the at least one magnetic sheet, and generate a presence signal in response to the detection;
wherein the processor is configured to receive and process the presence signal received from the magnetic sensor component and determine whether the food container has been moved.

4. The real-time pantry inventory management system of claim 1, wherein the plurality of presence sensors further comprise a gyroscope and acceleration sensor, and wherein the processor is configured to monitor a change in axis values of the gyroscope and acceleration sensor, determine if the change in axis values exceeds a predetermined threshold, and identify the food container being moved.

5. The real-time pantry inventory management system of claim 1, wherein the plurality of presence sensors further comprise a tilt and vibration sensor configured to monitor the movement of each of the plurality of food containers until the food container remains stable on the storage element.

6. The real-time pantry inventory management system of claim 1, wherein at least one of the plurality of weight sensors is configured to have first and second parts, the first part being placed against the side wall of the pantry and a second part positioned on the storage element, where each of the plurality of weight sensors being configured to generate a real-time weight signal in response to a weigh change on the storage element;
the processor is configured to process the real-time weight signal received from each of the plurality of weight sensor, identify if a weight sensor is touching the storage element, and calculate the weight of the food items placed on the storage element.

7. The real-time pantry inventory management system of claim 6, wherein the processor is configured to calibrate each weight sensor each time the weight sensor is affixed to the storage element, and generate calibration data for storage in at least one database selected from a local database and a cloud-based database.

8. The real-time pantry inventory management system of claim 1, further comprising:
at least one database selected from a cloud-based database and a local database for storing all inventory data; and
a mobile app configured to access the inventory data stored in the at least one database;
wherein the mobile app is configured to enable a user to access the inventory data remotely.

9. The real-time pantry inventory management system of claim 8, wherein the mobile app is configured to automatically identify food items that weigh below predetermined thresholds, automatically create a shopping list, and automatically place a shopping order for the identified food items.

10. The real-time pantry inventory management system of claim 1, wherein at least one of the plurality of presence sensors is housed in a case that has an opening in the bottom of the case, and the presence sensor is in proximity to the storage element when the food container is placed on the storage element;
the presence sensor further comprises:
a battery;
a U-shaped pin made of a conducting material, one leg of the U-shaped pin substantially longer than the other leg, wherein the longer leg can protrude through the opening of the case when the presence sensor and the food container are lifted off the storage element; and
a plate made of a conducting material configured to generate an electrical current when the U-shaped pin touches the plate.

11. A method of real-time pantry inventory management, comprising:
receiving real-time presence data from a plurality of presence sensors affixed to a plurality of food containers storing a plurality of food items being supported by a storage element;
receiving real-time weight data from at least one weight sensor coupled to the storage element;
processing the real-time presence data and the real-time weight data;
automatically determining if the weight of the food items is under predetermined thresholds and generating inventory data; and
automatically determining a real-time inventory of food items associated with the storage element.

12. The method of real-time pantry inventory management of claim 11, comprising:
assigning a unique identifier to each of the plurality of food containers.

13. The method of real-time pantry inventory management of claim 11, comprising:
putting at least one magnetic sheet on the storage element,
putting the plurality of food containers on at least one magnetic sheet;
detecting if the food container remains on the at least one magnetic sheet through a magnetic sensor component of each of the plurality of presence sensors;
generating a presence signal in response to the detection;
receiving and processing the presence signal received from the magnetic sensor component; and
determining whether the food container has been moved.

14. The method of real-time pantry inventory management of claim 11, comprising identifying axis values of the plurality of food containers via a gyroscope and acceleration sensor of each of the plurality of presence sensors;
monitoring a change in axis values of the gyroscope and acceleration sensor;
determining if the change in axis values exceeds a predetermined threshold; and
identifying the food container being moved.

15. The method of real-time pantry inventory management of claim 11, comprising:
monitoring the movement of each of the plurality of food containers until the food container remains stable on the storage element via a tilt and vibration sensor of each of the plurality of presence sensors.

16. The method of real-time pantry inventory management of claim 11, comprising:
generating a real-time weight signal in response to a weight change on the storage element via each of the plurality of weigh sensors;
processing the real-time weight signal received from each of the plurality of weight sensors;
identifying if a weight sensor is touching the storage element; and
calculating the weight of the food items placed on the storage element.

17. The method of real-time pantry inventory management of claim 11, comprising:
calibrating each weight sensor each time the weight sensor is affixed to the storage element; and
generating calibration data for storage in at least one database selected from a local database and a cloud-based database.

18. The method of real-time pantry inventory management of claim 11, comprising:
storing all the inventory data in at least one database selected from a cloud-based database and a local database;
accessing the inventory data stored in the at least one database via a mobile app; and
reviewing the inventory data remotely via the mobile app.

19. The method of real-time pantry inventory management of claim 11, comprising:
automatically identifying food items that weigh below predetermined thresholds;
automatically creating a shopping list; and
automatically placing a shopping order for the identified food items.

20. The method of real-time pantry inventory management of claim 19, comprising:
identifying retailers that offer a discount of the food items that weigh below predetermined thresholds; and
placing the shopping order with retailers that offer the best price with the highest ratings.
